(19) United States
(12) Patent Application Publication
(10) Pub. No.: US 2009/0109562 A1
(43) Pub. Date: Apr. 30, 2009

(54) DISPLAY HAVING A MIRROR ELEMENT

(75) Inventors: Guan-De Liou, Taipei City (TW); Chia-Pine Huang, Keelung City (TW); Stephen Tsai, Sijhih City (TW); Li-Li Lai, Taipei City (TW); Ming-Chun Lee, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HANNSPREE, INC., Taipei City (TW)

(21) Appl. No.: 12/013,248

(22) Filed: Jan. 11, 2008

(30) Foreign Application Priority Data
Oct. 26, 2007 (TW) 096140398

(51) Int. Cl. G02B 7/182

(52) U.S. Cl. 359/872

(57) ABSTRACT

A display having a mirror element is provided. The display comprises a display body with a screen housing and a mirror element disposed on the display body. The screen housing comprises a connecting member connecting the mirror element and the screen housing.

### FIELD OF THE INVENTION

The present invention relates to a mirroring display, especially to a display having a mirror element.

### BACKGROUND OF THE INVENTION

As technologies advance and improve, a personal computer becomes a requisite equipment for daily use, a display of the personal computer is a technical apparatus for a long time viewing. There are various kinds of displays commercially available in the market. Although the displays attracted customers to buy by showing the features, such as, size, shape, resolution, etc.

Human needs always drove peoples to invent new inventions. Besides the technologies improved, the human life was improved too. If the conventional displays only had a function to show video images, the customers' needs of various functions could not be met. Therefore, someone started to append the optical apparatus, such as, internet camera, onto the displays from individual setup mode into build-in mode to integrate them to break through the limited techniques of conventional displays, to improve the function of catching images, to save space, to simplify the display and to facilitate easy usage of the displays. An invention which was invented by combining a conventional technique frequently existed in our daily life.

The inventor tried to combine other optical instruments with a display based on the above conception. According to a rule, a technology was invented from human nature. The invention which met the human needs should get inspiration of innovation from improving the daily life needs.

There were a saying that to look beautiful is a woman's nature and another saying that a woman will apply cosmetics for whom she loves. A female paid much attention to her appearance. A single female who loved to look beautiful would felt troublesome as to how to arrange a personal computer, a mirror and a dressing table where cosmetics, toilet requisites were laid out for use at home. Especially, at downtown the houses were expensive and the space of her living room was limited. If she wanted to place a computer desk and a dressing table including a desktop mirror and other types of mirrors at her living room, extra space was needed. If she considered the decoration of her living room, some living space would be sacrificed and her living quality would decrease.

Similar problems could bother a female office employee. During her working, she needed to apply cosmetics and to arrange her appearance. Usually, at the office there were no sufficient space to accommodate a dressing table and desktop mirror because on her desk there were so many documentary files. Although she usually carried a mirror with her, the dimension of the mirror was too small to have enough reflection surface. The restroom where she could apply cosmetics on her face, located at a public area or at her company working area, she could not apply cosmetics at the restroom because it would not protect her privacy.

The above problem occurred because the space to place the mirror was lack. Therefore, if the space and the location to place the mirror was improved, the above problems can be solved. A display with an optical instrument, e.g. mirror, seems to be a fine solution which will meet the female needs.

From 13^{th} century a process for manufacturing a mirror had been improved. The cost was reduced to some extent but its function still remained to reflect a light. In optical paths of many optical instruments, such as, a telescope, a microscope, a laser and an industrial instrument, a mirror would be used to reflect a light. The most widely used mirror was used for cosmetics, combing and shaving of daily life usage as an instrument for regulate a personal appearance.

It will mean important to a female office employee who always needs to regulate her personal appearance to add a mirror onto her display. It will mean important to a male office employee too. Anyone shall pay attention to what he or she looks. To regulate his personal appearance will help him during working or in his social life to increase his confidence.

Further, anyone who usually worked in front of a personal computer and paid no attention to his appearance, this kind of invention can control the movements of persons surrounding him when he watched the screen of the personal computer. For example, he can control a person abruptly appears at his back. It is convincing that the conception of combining a mirror with a display is a product which meets human needs and combines human nature.

How to combine a mirror with a display is a problem to be severely faced. If them are simply combined, the structure of the display will be destroyed and the space will be wasted. The complex components added will make its usage more inconvenient. The invention will lose its value and object.

From the above, the problems need to be solved. Thus, how to rectify the foresaid conventional drawback is the main purpose of the present invention.

### SUMMARY OF THE INVENTION

According to one aspect of the present invention, the present invention provides a mirroring display comprising:

a display body having a screen housing; and

a mirror element disposed at the display body.

Preferably, the display body further comprises a supporting frame and a base, and the screen housing is connected to the supporting frame which is connected to the base.

Preferably, the supporting frame further comprises a recess receiving the mirror element.

Preferably, the mirror element further comprises a supporting protrusion for holding the mirror element by a user's hand to take the mirror element out from the recess.

Preferably, the base further comprises a base recess receiving the mirror.

Preferably, the mirror element further comprises a base protrusion for holding the mirror element by a user's hand to take the mirror element out from the base recess.

Preferably, the screen housing further comprises a screen recess on a side of the screen housing receiving therein the mirror element, the screen recess further comprises a side cover covering and uncovering the screen recess to form a screen cavity disposing therein the mirror element.

Preferably, the mirror element is disposed on the side cover and inside of the screen cavity and used when the side cover is opened and a viewing angle of the mirror element is regulated by regulating an opening extent of the side cover.

According to another aspect of the present invention, the present invention provides a mirroring display comprising:

a display body having a screen housing;

a mirror element; and

a connecting piece connecting the mirror element and the screen housing.

Preferably, the mirror element further comprises a mirror housing protecting the mirror and connected to the connecting piece.

Preferably, the mirror element further comprises a joint piece connected to the connecting piece for regulating a viewing angle of the mirror.

Preferably, the connecting piece is a hinge shaft for rotating the mirror element two-dimensionally and regulating a view angle of the mirror element.

Preferably, the connecting piece is an extension arm having a first end connected to a side of the screen housing and a second end connected to the mirror element.

Preferably, the extension arm further comprises a rotating shaft connected to the screen housing for rotating the extension arm two-dimensionally in 360 degrees.

Preferably, the screen housing further comprises an extension recess provided on a side of the screen housing having a defining surface receiving the extension arm and the mirror element therein.

Preferably, the mirroring display further comprises a cover covering and uncovering the recess, wherein the cover and the recess form a extension cavity for receiving the extension arm and the mirror element therein.

Preferably, the connecting piece is a connecting arm having a first terminal connected to a side of the screen housing and a second terminal connected to the mirror element.

Preferably, the mirror element further comprises a combining piece detachably connecting the connecting arm.

Preferably, the connecting arm further comprises a rotating shaft disposed between the connecting arm and the screen housing for rotating the mirror element.

Preferably, the connecting arm includes a support supporting the mirror element while the support is separated from the connecting arm therefrom.

The foregoing and other features and advantages of the present invention will be more clearly understood through the following descriptions with reference to the drawings, wherein:

### BRIEF DESCRIPTION OF THE DRAWINGS

FIG. 1a perspective view of a first preferred embodiment of a display having a mirror element of the present invention;

FIG. 2 is a rear view of the first preferred embodiment of the display having a mirror element in FIG. 1;

FIG. 3 is a perspective view of a second embodiment of a display having a mirror element of the present invention;

FIG. 4 is a perspective view of a third embodiment of a display having a mirror element of the present invention;

FIG. 5 is a perspective view of the third embodiment of the present invention in which the side cover is closed;

FIG. 6 is a perspective view of the fourth embodiment of a display having a mirror element of the present invention;

FIG. 7 is a perspective view of the fifth embodiment of a display having a mirror element of the present invention;

FIG. 8 is a perspective view of the fifth embodiment of the present invention in which the side cover is closed;

FIG. 9 is a perspective view of the sixth embodiment of the display having a mirror element of the present invention;

FIG. 10(a) is a view of a detachable mirror and a connecting arm of the seventh embodiment of the present invention;

FIG. 10(b) is a side view of the detachable mirror of the seventh embodiment of the present invention; and

FIG. 11 is a perspective view of the eighth embodiment of a display having a mirror element.

### DETAILED DESCRIPTION OF THE PREFERRED EMBODIMENT

The present invention will now described more specifically with reference to the following embodiments.

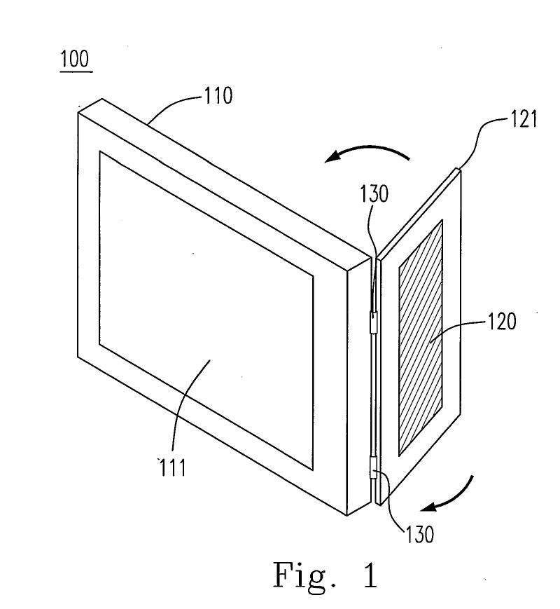

Please refer to FIG. 1 which is a perspective view of a first preferred embodiment of a display having a mirror element of the present invention. In FIG. 1, the display 100 comprises a screen housing 110, a screen 111, a mirror housing 121 which comprises a mirror 120 and at least a hinge shaft 130. The screen housing 110 is disposed at a periphery of the screen 111. The hinge shaft 130 is disposed at a side of the screen housing 110. The hinge shaft 130 is connected to the mirror housing 121 for rotating the mirror housing 121 and the mirror 120 behind a back side of the display 100.

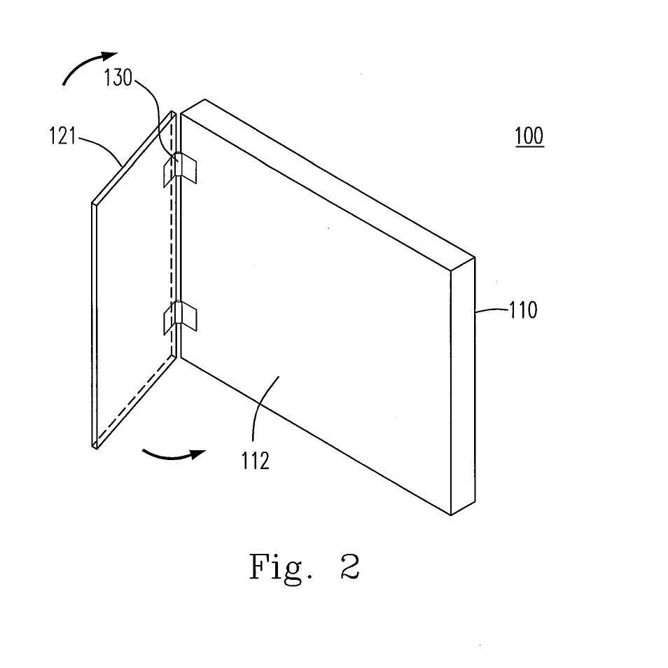

Please refer to FIG. 2 which a rear view of the first preferred embodiment of the display having a mirror element in FIG. 1. When the mirror housing 121 and mirror 120 is rotated to the rear side of the display 100, the mirror 120 can rotate to the back surface 112 of the screen housing 110. In the first preferred embodiment, the hinge shaft 130 has a similar structure to a door shaft. Because the hinge shaft 130 is disposed at a side of the back surface 112 of the screen housing 110, the rotating angle of the hinge shaft 130 is between 0 to 270 degrees. The hinge shaft 130 can be designed into an other hinge structure with a different rotating angle range based on a function of the hinge structure. But, the mirror 120 and the mirror housing 121 shall be rotated to a back side of the display 100 by using the hinge structure.

The dimension and size of the mirror 120 and the mirror housing 121 can be regulated when it is necessary. The dimension and size do not necessarily conform to that of the screen housing. Besides a shape of the mirror 120 can be rectangular, other shapes, such as round, ellipse, triangular, etc., can be used. The mirror housing 121 can not be used, in this way, the mirror 120 is directly connected to the hinge shaft 130 while the mirror 120 rotates with a rotating angle of 0-270 degrees. The location of the hinge shaft 130 is not limited to a left side of the back surface 112 of the screen housing 110 shown in FIG. 1. It is allowable to dispose the hinge shaft 130 at a right side or upper side of the back surface 112 of the screen housing 110.

It shall be noted that because the present invention relates to a display having a mirror element, the phase “the mirror” in the first example and other following Examples is not only referred to a mirror adhered on a glass by plating a material, such as, silver, mercury, aluminum, etc., but also the mirror includes an other mirror component having specular reflection.

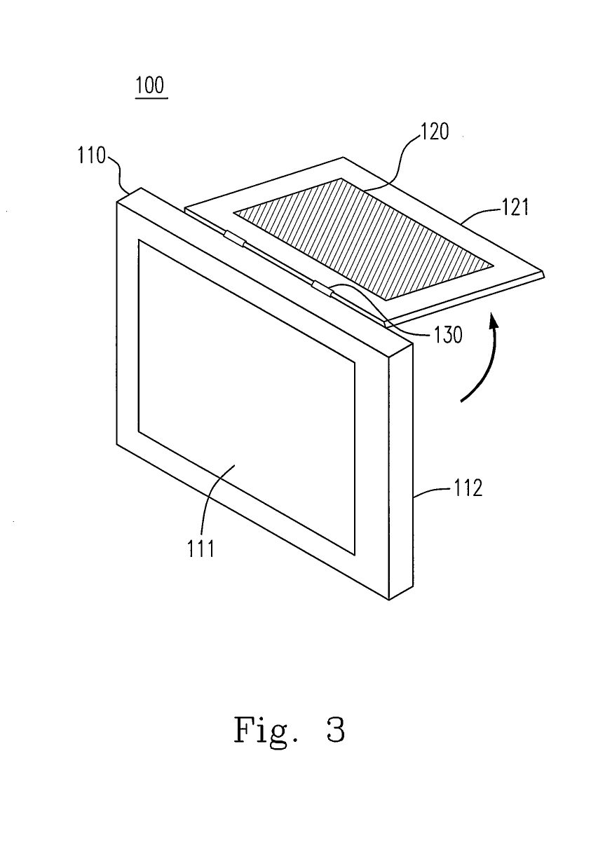

Please refer to FIG. 3 which is a perspective view of a second embodiment of a display 100 having a mirror element of the present invention. In FIG. 3, the hinge shaft 130 is disposed at an upper edge of the back surface 112 of the screen housing 110, usually is hidden at the rear of the display 100 and is located near the back surface 112. As in the Example 1, the mirror 120 can rotate with a rotating angle of 0-270 degrees relative to the mirror housing 121. The mirror 120 can extend out from the back surface 112 of the display 100 by rotating.

From FIGS. 1, 2 and 3, it is found the mirror can be attached with a display without destroying an existing structure of the display in the present invention.

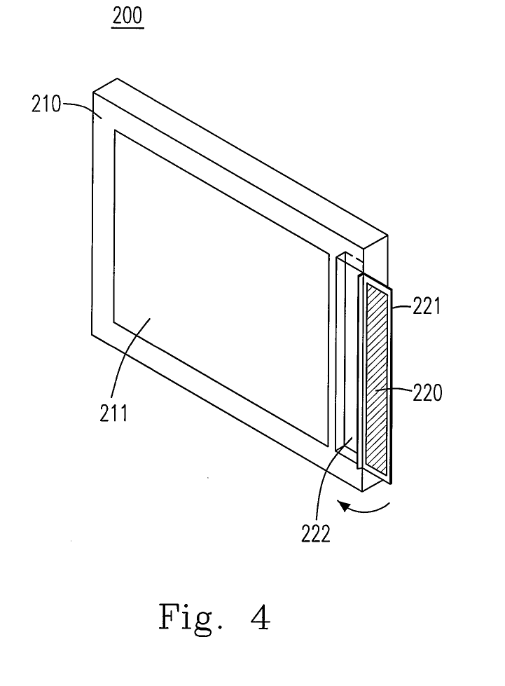

Please refer to FIG. 4 which is a perspective view of a third embodiment of a display 200 having a mirror element of the present invention. The display 200 includes a screen housing 210, a screen 211, a mirror 220, a side cover 221 and a screen recess 222. In this Example 3, the screen recess 222 covered by a side cover 221 is disposed at a side of the screen housing 210. A hinge is mounted between the side cover 221 and the screen housing 210 to cover and uncover the screen recess 222. When the side cover 221 is closed, it can completely cover the screen recess 222 to form a screen cavity for disposing the mirror 220 therein. When the side cover 221 is opened, a viewing angle of the mirror 220 can be regulated by regulating an opening extent of the side cover 221 with a rotating angle of 0-270 degrees.

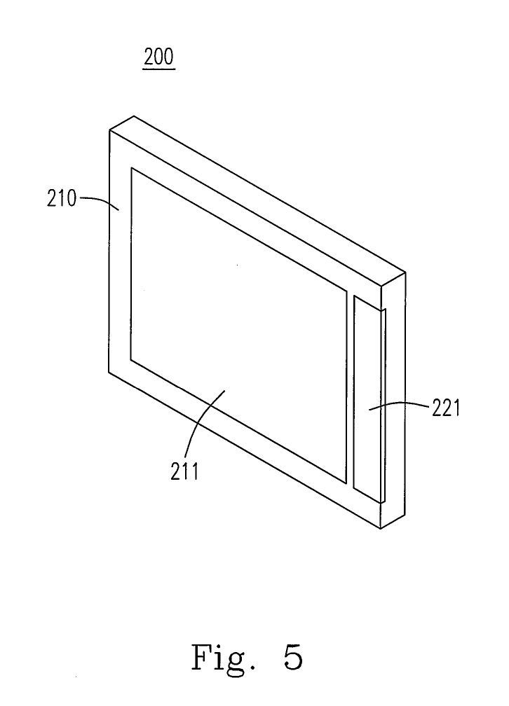

It shall be noted that the screen cavity formed by the side cover 221 and the screen recess 222 in the Example 3 not only can be disposed at the left and right sides but also can be disposed at the upper and down sides. When it is necessary, four mirrors can be mounted on the left, right, upper and down sides of the screen 211. As shown in FIG. 5, the side cover 221 is closed. The dimension, shape and arrangement can be regulated to meet a special need without affecting the covering and uncovering of the side cover 221. Preferably the dimension range of the mirror 220 shall not extent beyond the dimension and shape of the side cover 221.

FIG. 5 is a perspective view of the fourth embodiment of the present invention in which the side cover 221 is closed. As shown in FIG. 5, after the side cover 221 is closed, the screen 210 of the display 200 seems to be integrally formed with the side cover 221. The arrangements can not only allow the display 200 to have mirror function but also maintain the appearance of the display 200 in perfect condition.

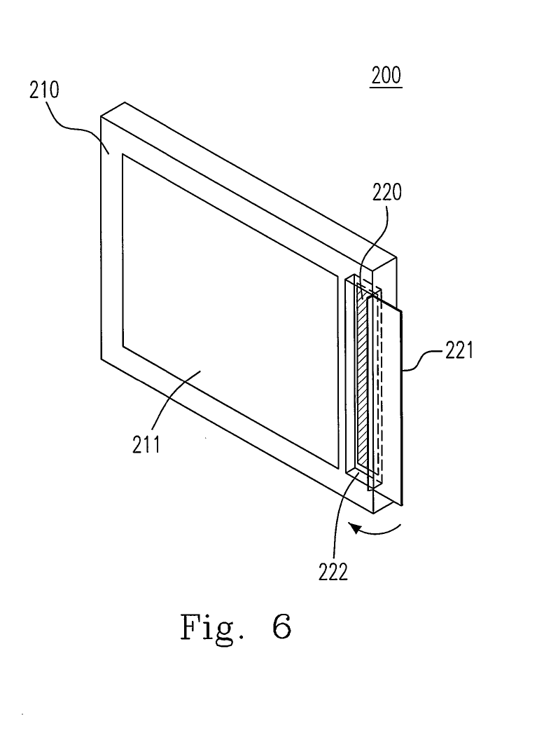

The mirror 220 in the above examples not only can be disposed on the side cover 221 but also on an inner surface of the screen recess 222 to allow a user to use the mirror when the side cover 221 is opened. Please refer to FIG. 6 which is a perspective view of the fourth embodiment of a display 200 having a mirror element of the present invention. As shown in FIG. 6, the mirror 220 is adhered to an inner surface of the screen recess 222 to hide the mirror 220 after the side cover 221 is closed.

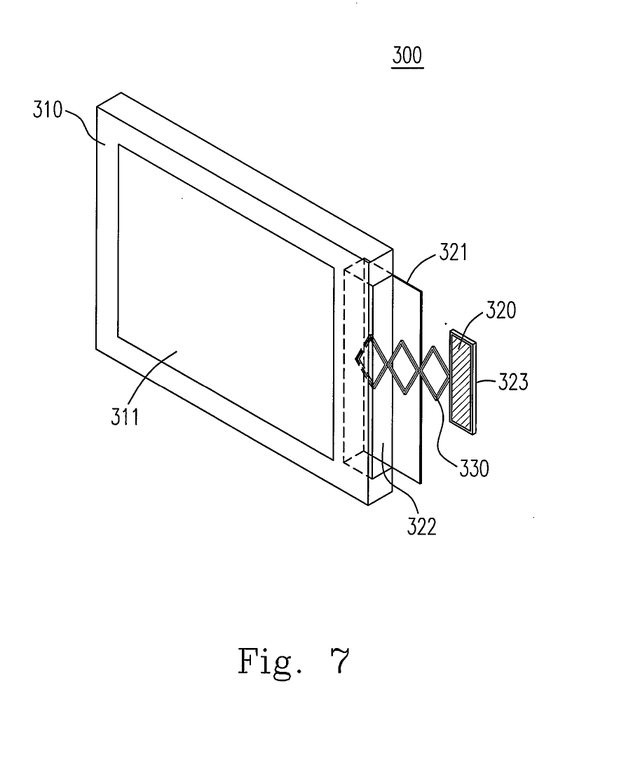

Please refer to FIG. 7 which is a perspective view of the fifth embodiment of a display 300 having a mirror element of the present invention. The display 300 includes a screen housing 310, a screen 311, a mirror 320, a side cover 321, an extension recess 322 and an extension arm 330. In the fifth embodiment, the extension recess 322 is disposed at a side of the screen housing 310. The extension arm 330 includes an first end connected to a side of the extension recess 322 and a second end connected to a mirror housing 323 encompassing the mirror 320.

In the fifth embodiment, the mirror housing 323 may not be disposed. The mirror 320 can be directly connected to the extension arm 330. The extension recess 322 not only can be disposed at a side of the screen housing 310 but also can be disposed at opposite side and upper side of the screen housing 310.

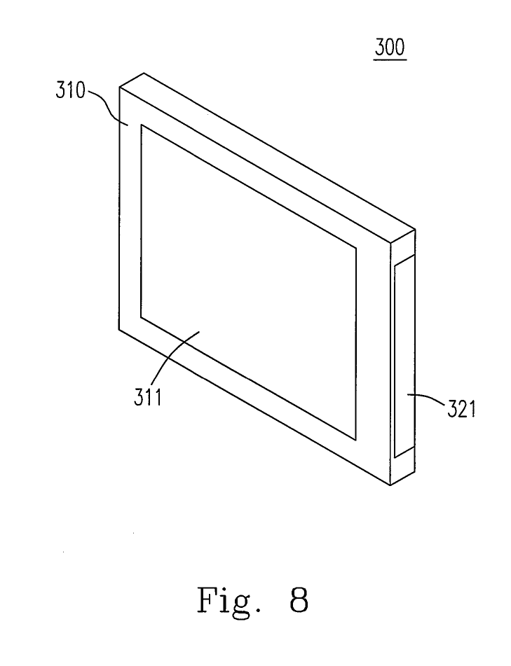

In the embodiment of the FIG. 7, the mirror 320 and mirror housing 323 can be drawn from the extension recess 322 by extending the extension arm 330 for facilitating usage. The direction of extending the extension arm 330 can be regulated by special needs. When the mirror 320 is not needed to be used, the mirror 320, mirror housing 323 and the extension arm 330 can be received into the extension recess 322. After them are received into the extension recess 322 and the side cover 321 is closed, the extension arm 330, mirror 320 and mirror housing 323 can be hidden as shown in FIG. 8.

Please refer to FIG. 8 which is a perspective view of the fifth embodiment of the present invention in which the side cover 321 is closed. When the side cover 321 is closed, the screen housing 310 of the display 300 seems to be integrally formed with the side cover 321. The arrangement of FIG. 8 maintains the appearance of the display 300 and an additional function of the display 300.

It shall be emphasized that in the fifth embodiment of FIG. 8, the side cover can be neglected for facilitating the user's usage so that the mirror 320, mirror housing 323 and extension arm 330 are received into the extension recess 322.

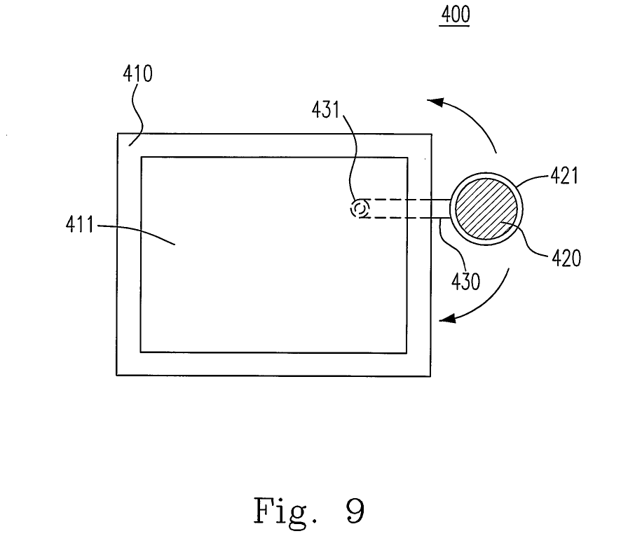

Please refer to FIG. 9 which is a perspective view of the sixth embodiment of the display 400 having a mirror element of the present invention. The display 400 includes a screen housing 410, a screen 411, a mirror 420, a mirror housing 421, a connecting arm 430 and a first rotating shaft 431.

In the sixth embodiment of the present invention, a first rotating shaft 431 for connecting the screen housing 410 and the connecting arm 430 is mounted between the screen housing 410 at the rear of the display 400 and a first terminal of the connecting arm 430. A second terminal of the connecting arm 430 is connected to the mirror housing 421 encompassing the mirror 420. The first rotating shaft 431 is of a rotor shaft structure for rotating the connecting arm 430 which drives the mirror 420 and the mirror housing 421 two-dimensionally in 360 degrees. When the mirror 420 and the mirror housing 421 are not needed to be used, they can be hidden at the rear of the display 400.

It shall be noted that in the sixth embodiment of the present invention, the connecting arm 430 can be replaced by the extension arm 330 in the fifth embodiment of FIG. 7 which is connected to the first rotating shaft 431 and which can be hidden at the rear of the display without wasting space.

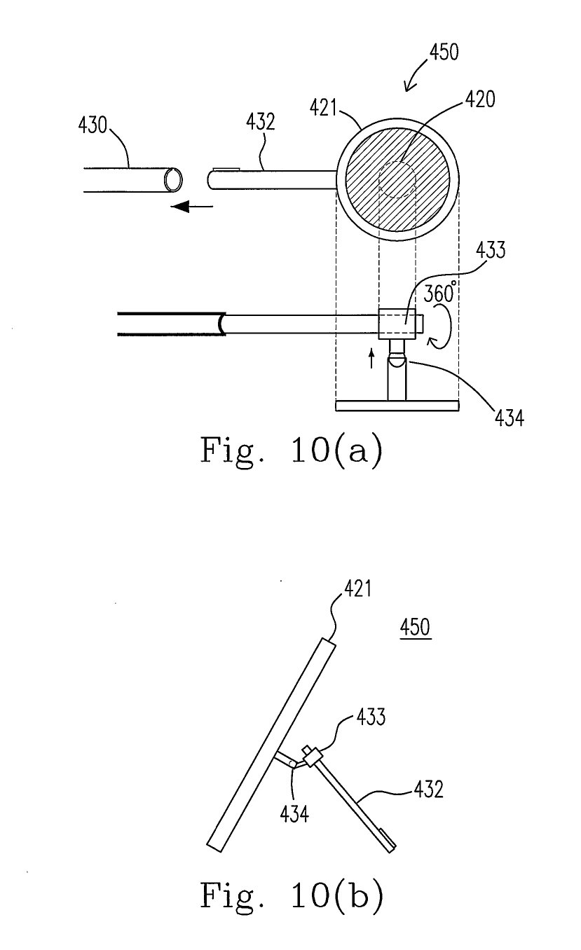

Alternatively, the mirror housing 421 can be neglected and it is feasible to connect the above components to the mirror 420. For facilitating the user's usage, a connecting piece or a combining piece, such as a ball joint shaft, having a rotating shaft can be mounted on the screen housing 421 for freely regulating a viewing angle of the mirror 420 as shown in FIG. 10(a).

Please refer to FIG. 10(a) which is a view of a detachable mirror 450 and a connecting arm 430 of the seventh embodiment of the present invention. The seventh embodiment is based on the sixth embodiment and both structures are similar from the display to the connecting arm except that an additive structure design between the mirror 420 and the connecting arm 430 is mounted. The additive structure design has the mirror 420 in combination with surrounding structures to form the detachable mirror 450 to enhance the usage flexibility of the mirror 420, to increase user's convenience and to increase more functions of the present invention.

In FIG. 10(a), the mirror 420 of the detachable mirror 450 is encompassed by a mirror housing 421 connected to a first end of the ball joint shaft 434 having a second end connected to a second rotating shaft 433. The second rotating shaft 433 is connected to a combining arm 432 which is a combining piece. The combining arm 432 which is connected to a end of the connecting arm 430.

In the seventh embodiment, the second rotating shaft 433 and the first rotating shaft 431 have a rotor shaft structure and can drive the ball joint shaft 434 and mirror 420 to rotate two-dimensionally. A viewing angle of the mirror 420 can be regulated by the ball joint shaft 434. Please refer to FIG. 10(b) which is a side view of the detachable mirror 450 of the present invention. As shown in FIG. 10(b), after the detachable mirror 450 is separated from the connecting arm 430, the combining arm 432 is used as a support 432 for supporting the mirror components including the mirror 420 and the mirror housing 421 on a desk surface independently.

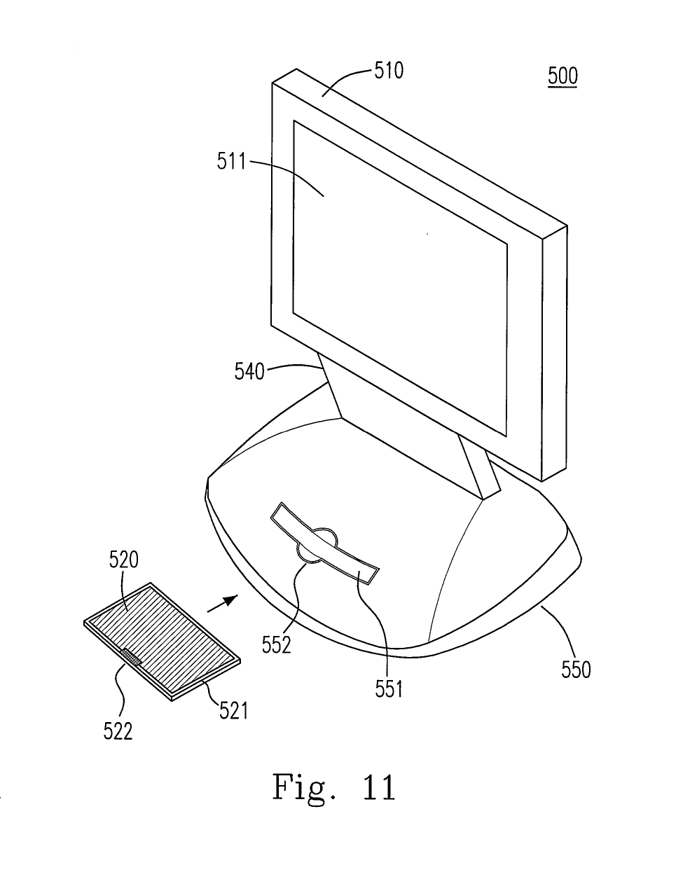

Please refer to FIG. 11 which a perspective view of the eighth embodiment of a display 500 having a mirror element. The display 500 has a screen 511 and a screen housing 510. A supporting frame 540 is connected to the rear of the screen housing 510 and to a base 550. A base recess 551 is disposed on the base 550 for receiving a mirror 520 and a mirror housing 521.

In order to facilitate the user to take the mirror 520 out of the base recess 551, a holding protrusion 522 is formed on the mirror housing 521. A protrusion recess 552 is formed at a corresponding location to the holding protrusion 522 when the mirror 520 is inserted into the seat recess 551. When a finger of the user is extended and the user presses on the holding protrusion 522, the mirror 520 is drawn from the base recess 551.

The principle of disposing the mirror 520 into the base recess 551 of the base 550 can be applied on other locations on the display than the location of the base 550. For example, provided that the mirror can be hidden and received and the user feels it convenient, the base recess 551 can be placed on the screen housing 510 or on the supporting frame 540.

From the above embodiments, the above embodiments of the present invention is used to facilitate the user's usage and to properly arrange the space in order to hide the mirror at the back of the display. The display having a mirror element which has versatile purposes and low production costs is formed.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A mirroring display, comprising:
a display body having a screen housing; and
a mirror element disposed at the display body.

2. The mirroring display according to claim 1, wherein the display body further comprises a supporting frame and a base, and the screen housing is connected to the supporting frame which is connected to the base.

3. The mirroring display according to claim 2, wherein the supporting frame further comprises a recess receiving the mirror element.

4. The mirroring display according to claim 3, wherein the mirror element further comprises a first holding protrusion.

5. The mirroring display according to claim 2, wherein the base further comprises a base recess receiving the mirror element.

6. The mirroring display according to claim 5, wherein the mirror element further comprises a second holding protrusion for fitting the base recess.

7. The mirroring display according to claim 1, wherein the screen housing further comprises a screen recess on a side of the screen housing receiving therein the mirror element, and a side cover covering and uncovering the screen recess to form a screen cavity disposing therein the mirror element.

8. The mirroring display according to claim 7, wherein the mirror element is disposed inside the side cover.

9. A mirroring display, comprising:
a display body having a screen housing;
a mirror element; and
a connecting member connecting the mirror element and the screen housing.

10. The mirroring display according to claim 9, wherein the mirror element further comprises a mirror housing surrounding the mirror element and connected to the connecting member.

11. The mirroring display according to claim 9, wherein the mirror element further comprises a joint member connected to the connecting member for regulating a viewing angle of the mirror element.

12. The mirroring display according to claim 9, wherein the connecting member is a hinge shaft rotating the mirror element two-dimensionally.

13. The mirroring display according to claim 9, wherein the connecting member is an extension arm having a first end connected to a side of the screen housing and a second end connected to the mirror element.

14. The mirroring display according to claim 13, wherein the extension arm further comprises a rotating shaft connected to the screen housing for rotating the extension arm two-dimensionally in 360 degrees.

15. The mirroring display according to claim 13, wherein the screen housing further comprises a recess provided on a side of the screen housing, the recess has a defining surface and receives the extension arm and the mirror element therein.

16. The mirroring display according to claim 15, further comprising a cover covering and uncovering the recess, wherein the cover and the recess forms a extension cavity receiving the extension arm and the mirror element therein.

17. The mirroring display according to claim 9, wherein the connecting member is a connecting arm having a first terminal connected to a side of the screen housing and a second terminal connected to the mirror element.

18. The mirroring display according to claim 9, wherein the mirror element further comprises a combining member detachably connecting to the connecting arm.

19. The mirroring display according to claim 17, wherein the connecting arm further comprises a rotating shaft disposed between the connecting arm and the screen housing.
